(19) United States
(12) Patent Application Publication
(10) Pub. No.: US 2025/0345878 A1
(43) Pub. Date: Nov. 13, 2025

(54) RESISTANCE SPOT WELDING WITH LASER WELDING FOR DISSIMILAR METAL SPOT-WELD JOINTS

(71) Applicant: GM GLOBAL TECHNOLOGY OPERATIONS LLC, DETROIT, MI (US)

(72) Inventors: Masoud MohammadPour, Novi, MI (US); Hassan Ghassemi-Armaki, Northville, MI (US); Junjie Ma, Novi, MI (US); Blair E. Carlson, Ann Arbor, MI (US)

(21) Appl. No.: 18/662,209

(22) Filed: May 13, 2024

(51) Int. Cl. B23K 11/11; B23K 11/20; B23K 26/346; B23K 101/00

(52) U.S. Cl. CPC B23K 11/115; B23K 11/20; B23K 26/346; B23K 2101/006

(57) ABSTRACT

Aspects of the disclosure include a joining strategy for resistance spot welding joints and components manufactured using the same. An exemplary vehicle includes a welded component having two or more layers. The welded component includes a first metal layer having a first conductivity and a second metal layer having a second conductivity. The first metal layer and the second metal layer are joined at a faying interface of a resistance spot-weld joint. The resistance spot-weld joint includes a continuous intermetallic layer at the faying interface directly between the first metal layer and the second metal layer and a pair of laser welds positioned on opposite sides of the continuous intermetallic layer. The pair of laser welds penetrate through the second metal layer and terminate within the first metal layer. The pair of laser welds extend into the first metal layer beyond a topmost surface of the continuous intermetallic layer.

### INTRODUCTION

The present disclosure relates to welding and parts manufacturing, and particularly to the use of resistance spot welding with laser welding when forming dissimilar metal spot-weld joints.

Resistance spot welding is a widely used joining technique in the manufacturing industry, particularly in the automotive, aerospace, and appliance sectors. Resistance spot welding is a welding process where two or more metal sheets are joined together by the heat generated from the electrical resistance to the flow of current through the joined materials. The basic resistance spot welding process involves clamping the metal sheets firmly between two electrode tips (often copper alloy) and passing an electrical current through the electrode tips and into the clamped metal sheets, causing localized heating at the interface between the sheets. The heat generated by electrical resistance causes the metals at the joint interface to melt and form a weld nugget. Once the current is turned off, the molten metal weld nugget solidifies, creating a so-called spot-welded joint.

Laser welding technologies are increasingly used in a range of manufacturing sectors such as the aero-space industry and automotive industry to take advantage of the high quality, high accuracy, and high speed welds offered by such laser welding systems. When laser welding, a plasma-plume with micro size metal particles can be produced at the surface of the work piece irradiated by the laser beam. For example, when irradiating a steel sheet coated with an anti-corrosive agent (e.g., zinc), the coating and the base material can be vaporized and plasmarized to produce an ion. These ions then cool, forming a particulate that often floats in air. The resultant particulate can be relatively thick, forming a cloud-like region over the work piece that blocks some or all of the laser beam.

### SUMMARY

In one exemplary embodiment a vehicle includes a welded component having two or more layers. The welded component includes a first metal layer having a first conductivity and a second metal layer having a second conductivity. The first metal layer and the second metal layer are joined at a faying interface of a resistance spot-weld joint. The resistance spot-weld joint includes a continuous intermetallic layer at the faying interface directly between the first metal layer and the second metal layer and a pair of laser welds positioned on opposite sides of the continuous intermetallic layer. The pair of laser welds penetrate through the second metal layer and terminate within the first metal layer. The pair of laser welds extend into the first metal layer beyond a topmost surface of the continuous intermetallic layer.

In addition to one or more of the features described herein, in some embodiments, the welded component further includes a third metal layer. In some embodiments, the third metal layer includes a third conductivity different than the first conductivity.

In some embodiments, the resistance spot-weld joint further includes a weld nugget between the second metal layer and the third metal layer.

In some embodiments, at least one of the laser welds of the pair of laser welds is perpendicular to a major surface of the welded component.

In some embodiments, at least one of the laser welds of the pair of laser welds is positioned at an angle towards the continuous intermetallic layer with respect to a major surface of the welded component.

In some embodiments, the angle is between 30 and 90 degrees with respect to the major surface of the welded component.

In some embodiments, the pair of laser welds are positioned symmetrically about a centerline of the continuous intermetallic layer.

In another exemplary embodiment a welded component includes a first metal layer having a first conductivity and a second metal layer having a second conductivity. The first metal layer and the second metal layer are joined at a faying interface of a resistance spot-weld joint. The resistance spot-weld joint includes a continuous intermetallic layer at the faying interface directly between the first metal layer and the second metal layer and a pair of laser welds positioned on opposite sides of the continuous intermetallic layer. The pair of laser welds penetrate through the second metal layer and terminate within the first metal layer. The pair of laser welds extend into the first metal layer beyond a topmost surface of the continuous intermetallic layer.

In some embodiments, the welded component further includes a third metal layer. In some embodiments, the third metal layer includes a third conductivity different than the first conductivity.

In some embodiments, the resistance spot-weld joint further includes a weld nugget between the second metal layer and the third metal layer.

In some embodiments, at least one of the laser welds of the pair of laser welds is perpendicular to a major surface of the welded component.

In some embodiments, at least one of the laser welds of the pair of laser welds is positioned at an angle towards the continuous intermetallic layer with respect to a major surface of the welded component.

In some embodiments, the angle is between 30 and 90 degrees with respect to the major surface of the welded component.

In some embodiments, the pair of laser welds are positioned symmetrically about a centerline of the continuous intermetallic layer.

In yet another exemplary embodiment a method can include providing a first metal layer having a first conductivity and providing a second metal layer having a second conductivity different than the first conductivity. The method can include joining the first metal layer to the second metal layer at a faying interface using resistance spot welding, thereby forming a resistance spot-weld joint. The resistance spot-weld joint can include a continuous intermetallic layer at the faying interface directly between the first metal layer and the second metal layer. The method can include forming a pair of laser welds on opposite sides of the continuous intermetallic layer. The pair of laser welds penetrate through the second metal layer and terminate within the first metal layer. The pair of laser welds extend into the first metal layer beyond a topmost surface of the continuous intermetallic layer.

In some embodiments, the method includes providing a third metal layer. In some embodiments, the third metal layer includes a third conductivity different than the first conductivity.

In some embodiments, the resistance spot-weld joint further includes a weld nugget between the second metal layer and the third metal layer.

In some embodiments, at least one of the laser welds of the pair of laser welds is perpendicular to a major surface of the welded component.

In some embodiments, at least one of the laser welds of the pair of laser welds is positioned at an angle towards the continuous intermetallic layer with respect to a major surface of the welded component. In some embodiments, the angle is between 30 and 90 degrees with respect to the major surface of the welded component.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2 is a detailed view of one or more components of the body of the vehicle of FIG. 1 in accordance with one or more embodiments;

FIGS. 3A, 3B, and 3C illustrate an example process for joining dissimilar metals using a combination of resistance spot welding and laser welding in accordance with one or more embodiments;

FIG. 4 is an example spot-weld joint with two or more dissimilar metals in accordance with one or more embodiments; and

FIG. 5 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Spot-weld joints are a common type of fusion welding used to join overlapping metal sheets or components. These joints are characterized by discrete, localized weld points rather than continuous welds along the entire seam between the joined parts. Spot-weld joints offer several advantages over continuous weld joints, such as speed, efficiency, and the ability to join relatively thin materials without distortion or warping. While there are several techniques available to create spot-weld joints, resistance spot welding is the most widely used spot welding process. Other spot welding techniques include laser spot welding, which uses a focused laser beam to melt the metal and form the weld, and ultrasonic spot welding, which combines the application of localized heat with high-frequency vibrations to create the joint. Each of these techniques offers their own unique characteristics and applications.

Unfortunately, resistance spot welding is primarily applicable to spot-weld joints made between sheets of the same metal material, as using resistance spot welding on dissimilar metals (that is, materials having different conductivities, such as aluminum and steel), results in the generation of a continuous intermetallic (IMC) layer at the joint interface. This IMC layer is naturally brittle and the main failure mode in spot-welds made by resistance spot welding is a fracture in the IMC layer. Moreover, mechanical testing of spot-welds made by resistance spot welding shows that the periphery of the weld can act as a stress concentration area that causes a crack(s) to initiate and propagate along the IMC layer at the faying interface (one or both of the surfaces in contact at the spot-weld joint). As a result, many manufacturing processes rely on mechanical joining methods such as self-pierce riveting (SPR), instead of resistance spot welding, when joining dissimilar metals, but these methods place other limits on manufacturing. For example, the use of high-strength steels causes SPR rivets to deform.

This disclosure introduces a new joining strategy to improve the mechanical performance of resistance spot welding joints. Rather than relying on resistance spot welding alone, a two-step welding process is proposed that includes both resistance spot welding and laser welding. In this two-step process, two (or more) dissimilar materials are pressed into a stack and resistance spot welding is used to create a spot-weld joint at the interface between the materials. After the IMC layer and weld nugget are formed, resistance spot welding is followed by laser welding at the periphery of the joint. In some embodiments, a pair of laser welds are positioned on opposite sides of the center of the weld nugget formed during resistance spot welding. In some embodiments, a pair of laser welds can be placed such that the IMC layer and/or weld nugget are fully contained between the laser welds.

Leveraging a hybrid resistance spot welding-laser spot welding joining strategy as described herein takes advantage of the strengths of both resistance spot welding and laser welding when joining two or more dissimilar metals, such as when connecting aluminum and steel. Notably, the introduced laser welds prevent the early initiation of cracks at the notch tip of the resulting weld, and slow crack propagation along the IMC interface by redirecting the crack growth path. Without wishing to be bound by theory, it is believed that this phenomenon helps to increase fracture load as well as displacement. Experimental observations in cross-tension tests have also shown hybrid resistance spot welding-laser spot welding spot-weld joints to have relatively enhanced joint strength when compared to spot-weld joints formed via resistance spot welding alone.

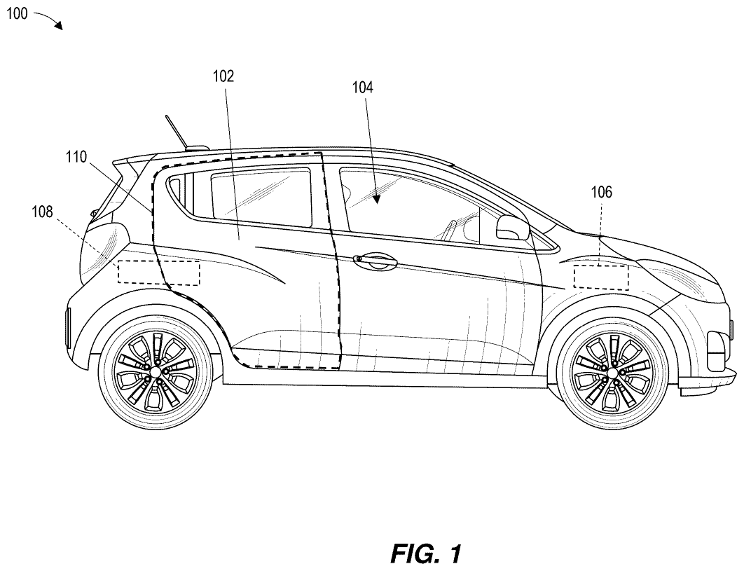

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed in the context of a vehicle 100 having an electric motor 106 and a battery pack 108, aspects described herein can be similarly incorporated within the components of vehicles having any propulsion system (e.g., combustion, hydrogen fuel cell, etc.). Moreover, aspects described herein need not be limited to vehicles at all and can similarly be incorporated within any work piece, vehicle component, building component, etc. having at least one spot-weld joint between dissimilar metals, and all such configurations and applications are within the contemplated scope of this disclosure.

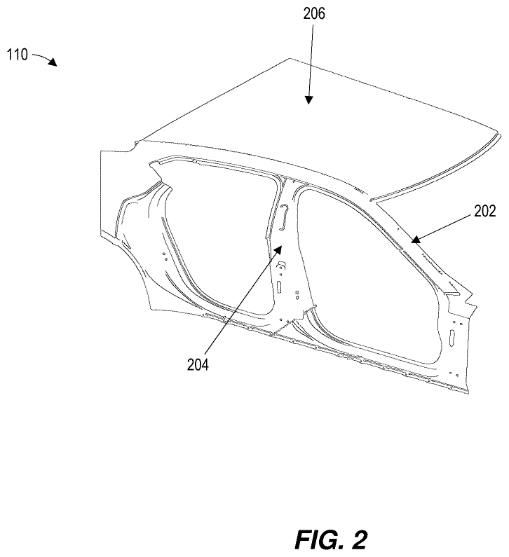

As will be detailed herein, one or more component(s) 110 of the body 102 (as shown for example only, a rear door) can include one or more spot-welds of two or more dissimilar metals in accordance with one or more embodiments. FIG. 2 shows a detailed view of one or more component(s) 110 of the body 102 of the vehicle 100 of FIG. 1 in accordance with one or more embodiments. As shown in FIG. 2, various (sub) components of the vehicle 100 can include dissimilar metal materials. For example, the A-pillar 202 (also known as the windshield pillar) that connects a vehicle's roof to the front-end structure or subframe, located on either side of the windshield, is often made of a 3-layer aluminum/steel 1/steel 2 stack. Similarly, the B-Pillar 204 (also known as the center pillar) that provides structural support and helps to reinforce the roof 206 and body, located between the front and rear doors on each side of the vehicle 100, is often made using a combination of aluminum and steel layers. These aluminum-steel hybrid components are often limited to mechanical joining methods as described previously. The components 110 shown in FIG. 2 are for ease of illustration and discussion only. It should be understood that any component(s) of the body 102 (and in fact, many components of the vehicle 100 generally) can be made in whole or in part by spot-welding metals using a combination of resistance spot welding and laser welding in accordance with one or more embodiments. For example, the roof 206 can be made in whole or in part by spot-welding metals using a combination of resistance spot welding and laser welding. Moreover, while the present disclosure is discussed primarily in the context of a component 110 of the vehicle 100 for ease of illustration and discussion, aspects described herein can be similarly incorporated within any manufacturing and construction application, including, but not limited to vehicles (e.g., as frames, shells, supports, etc., in automobiles, trains, trucks, ships, and aircraft), aerospace applications, buildings (as both structural and design components), and electronics (e.g., as substrates, supports, etc.), and all such configurations and applications are within the contemplated scope of this disclosure.

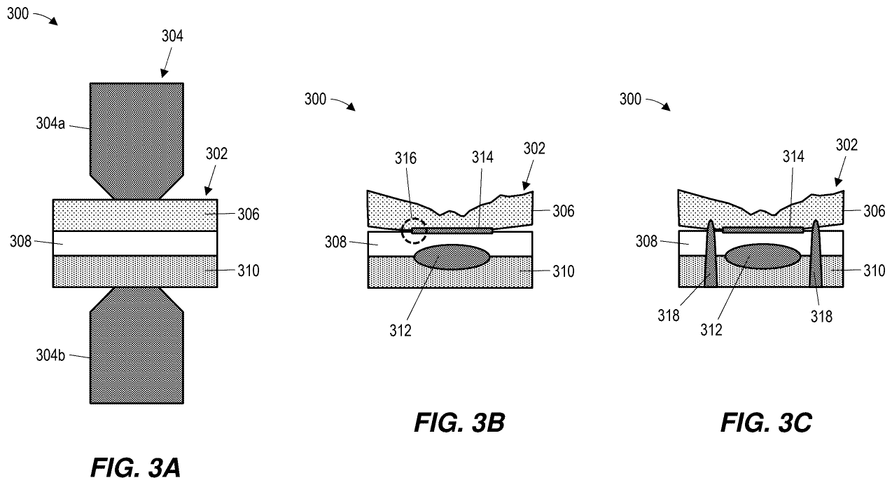

FIGS. 3A, 3B, and 3C illustrate an example process 300 for joining dissimilar metals using a combination of resistance spot welding and laser welding in accordance with one or more embodiments. As shown in FIG. 3A, process 300 begins by positioning a stack 302 between a jig, clamp, and/or vise 304 (collectively, jig 304). The jig 304 is not meant to be particularly limited, so long as the stack 302 can be fixed without shifting during the subsequent welding processes. In some embodiments, the jig 304 includes a first electrode 304a and a second electrode 304b.

In some embodiments, the stack 302 includes at least two dissimilar metal layers. For example, in some embodiments, the stack 302 includes an aluminum layer 306 having a first conductivity, a first steel layer 308 having a second conductivity different than the first conductivity, and a second steel layer 310 having a third conductivity. The third conductivity can be the same as, or different than, the second conductivity. The number of layers in the stack 302 is not meant to be particularly limited, so long as at least one of the layers has a first conductivity and at least one other of the layers has a second conductivity different than the first conductivity. For example, stack 302 can include 2, 3, 4, 5, 10, 15, or any number of layers, as desired. In some embodiments, the stack 302 is shaped into a work piece and/or component (e.g., the component 110 in FIGS. 1 and 2), although other applications (for structural and/or decorative components of vehicles, buildings, or otherwise) are within the contemplated scope of this disclosure as previously noted.

As shown in FIG. 3B, once the stack 302 is positioned in the jig 304, a first welding process is initiated whereby an electrical current is passed through electrode tips (not separately indicated) in the jig 304 and into the clamped stack 302, causing localized heating at the interface(s) between the layers in the stack 302, thereby joining the stack 302 by resistance spot welding. In some embodiments, resistance spot welding results in the formation of a weld nugget 312. For example, weld nugget 312 can form between the first steel layer 308 and the second steel layer 310 (as shown) as the joined layers melt and then cool. In some embodiments, resistance spot welding results in the formation of a IMC layer 314 at the faying interface 316 (also referred to as a joint interface). Mechanical testing of spot-weld joints made by resistance spot welding has shown that the periphery of these welds can act as stress concentration areas that can cause a crack(s) to initiate and propagate along the IMC layer 314 at the faying interface 316.

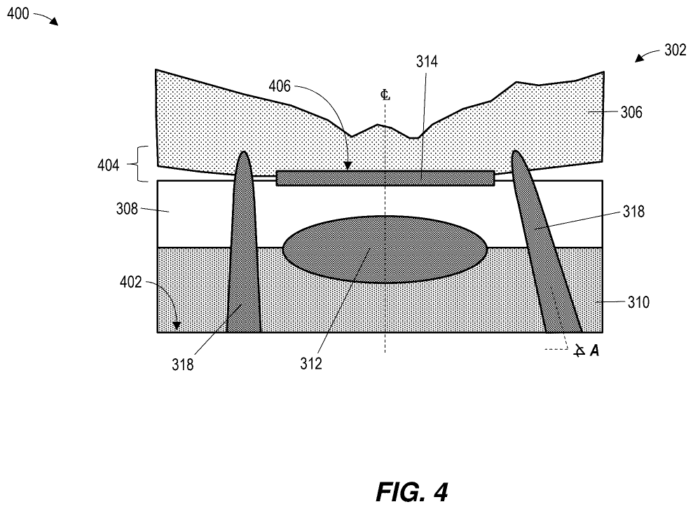

As shown in FIG. 3C, once the stack 302 is welded via resistance spot welding, a second welding process is initiated whereby laser welding is applied at the periphery of the IMC layer 314 and/or at the faying interface 316, thereby forming a pair of laser welds 318. In some embodiments, the laser welds 318 are positioned on opposite sides of the IMC layer 314. In some embodiments, the laser welds 318 are positioned on opposite sides of the weld nugget 312. In some embodiments, the laser welds 318 are positioned on opposite sides of both the IMC layer 314 and the weld nugget 312 (as shown). The laser welds 318 are discussed in greater detail with respect to FIG. 4.

FIG. 4 illustrates an example spot-weld joint 400 with two or more dissimilar metals in accordance with one or more embodiments. As shown in FIG. 4, spot-weld joint 400 includes a stack 302 having an aluminum layer 306, a first steel layer 308, and a second steel layer 310, in a similar manner as discussed with respect to FIGS. 3A, 3B, and 3C. Moreover, spot-weld joint 400 includes a weld nugget 312, IMC layer 314, and laser welds 318, formed by a two-step welding process that includes a first resistance spot welding step and a second laser spot welding step (refer to FIGS. 3B and 3C, respectively).

Weld profiles for the laser welds 318 are not meant to be particularly limited, but can include, for example, single or multiple circular and/or rectangular laser weld geometries applied at the periphery of the weld nugget 312 and/or IMC layer 314. In some embodiments, the laser welds 318 are symmetrically (within tooling limits) offset with respect to a centerline ¢ of the weld nugget 312 and/or IMC layer 314. For example, in some embodiments, circular welds of 5 to 20 mm, or 6 to 12 mm, or 11 mm, etc., can be placed at the periphery of the weld nugget 312 and/or IMC layer 314. In some embodiments, the size (diameter, depth, etc.) and/or offset of the laser welds 318 depends in part on the diameter of the weld nugget 312 and/or IMC layer 314. For example, the offset of the laser welds 318 can be at least 10 percent, or 20 percent, or 30 percent, or 40 percent, or 50 percent of the diameter of the weld nugget 312 and/or IMC layer 314.

In some embodiments, the laser welds 318 are positioned orthogonal (perpendicular) to a major surface 402 of the welded component (e.g., aluminum layer 306, first steel layer 308, second steel layer 310, etc. of the stack 302). In some embodiments, one or both of the laser welds 318 are angled with respect to the major surface 402. For example, one or more both of the laser welds 318 can be angled towards the IMC layer 314 at an angle A of between 90 degrees (perpendicular) to about 30 degrees (as shown in FIG. 4, about 60 degrees).

In some embodiments, the laser welds 318 partially penetrate into the aluminum layer 306 by an overlap margin 404 (as shown). Penetrating into an aluminum layer can mitigate aluminum melt mixing into the joined material layers, such as a steel weld pool when joining aluminum and steel sheets. The result is a relatively higher joint strength. The depth of the overlap margin 404 can vary depending on the thickness of the aluminum layer 306. In some embodiments, the overlap margin 404 has a depth of about 10, 20, 30, 40, 50, 60, 70 percent the total thickness of the aluminum layer 306. In some embodiments, the overlap margin 404 extends beyond a topmost surface 406 of the IMC layer 314 (as shown). Advantageously, laser welds 318 mitigate the early initiation of cracks at the IMC layer 314 and the propagation of cracks along the IMC layer 314 by redirecting crack growth paths.

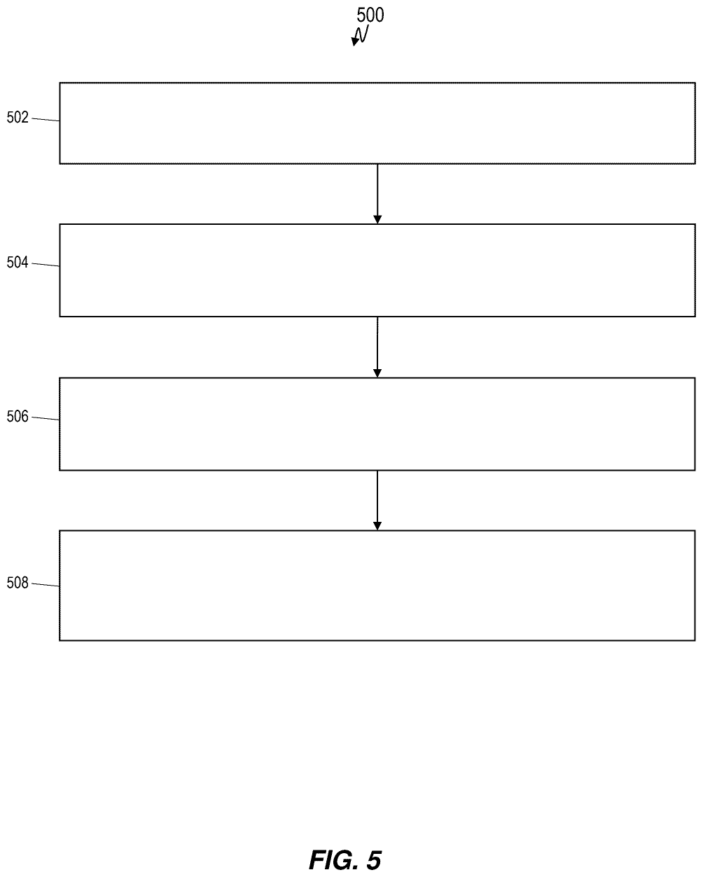

Referring now to FIG. 5, a flowchart 500 for combining resistance spot welding with laser welding when forming dissimilar metal spot-weld joints is generally shown according to an embodiment. The flowchart 500 is described in reference to FIGS. 1-4 and may include additional steps not depicted in FIG. 5. Although depicted in a particular order, the blocks depicted in FIG. 5 can be rearranged, subdivided, and/or combined.

At block 502, the method includes providing a first metal layer having a first conductivity. In some embodiments, the first metal layer is an aluminum layer.

At block 504, the method includes providing a second metal layer having a second conductivity different than the first conductivity. In some embodiments, the second metal layer is a steel layer.

At block 506, the method includes joining the first metal layer to the second metal layer at a faying interface using resistance spot welding (refer to FIGS. 3A and 3B), thereby forming a resistance spot-weld joint. In some embodiments, the resistance spot-weld joint includes a continuous intermetallic layer at the faying interface directly between the first metal layer and the second metal layer.

At block 508, the method includes forming a pair of laser welds on opposite sides of the continuous intermetallic layer (refer to FIG. 3C), the pair of laser welds penetrating through the second metal layer and terminating within the first metal layer, the pair of laser welds extending into the first metal layer beyond a topmost surface of the continuous intermetallic layer (refer to topmost surface 406).

In some embodiments, the method includes providing a third metal layer. In some embodiments, the third metal layer includes a third conductivity different than the first conductivity. In some embodiments, the third conductivity and the second conductivity are the same. In some embodiments, the third conductivity and the second conductivity are different.

In some embodiments, the method includes forming a weld nugget between the second metal layer and the third metal layer.

In some embodiments, at least one of the laser welds of the pair of laser welds is perpendicular to a major surface of the welded component.

In some embodiments, at least one of the laser welds of the pair of laser welds is positioned at an angle towards the continuous intermetallic layer with respect to a major surface of the welded component. In some embodiments, the angle is between 30 and 90 degrees with respect to the major surface of the welded component.

In some embodiments, the pair of laser welds are positioned symmetrically about a centerline of the continuous intermetallic layer.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a welded component having two or more layers, the welded component comprising:
a first metal layer comprising a first conductivity; and
a second metal layer comprising a second conductivity different than the first conductivity;
wherein the first metal layer and the second metal layer are joined at a faying interface of a resistance spot-weld joint, the resistance spot-weld joint comprising:
a continuous intermetallic layer at the faying interface directly between the first metal layer and the second metal layer; and
a pair of laser welds positioned on opposite sides of the continuous intermetallic layer, the pair of laser welds penetrating through the second metal layer and terminating within the first metal layer, the pair of laser welds extending into the first metal layer beyond a topmost surface of the continuous intermetallic layer.

2. The vehicle of claim 1, wherein the welded component further comprises a third metal layer, the third metal layer comprising a third conductivity different than the first conductivity.

3. The vehicle of claim 2, wherein the resistance spot-weld joint further comprises a weld nugget between the second metal layer and the third metal layer.

4. The vehicle of claim 1, wherein at least one of the laser welds of the pair of laser welds is perpendicular to a major surface of the welded component.

5. The vehicle of claim 1, wherein at least one of the laser welds of the pair of laser welds is positioned at an angle towards the continuous intermetallic layer with respect to a major surface of the welded component.

6. The vehicle of claim 5, wherein the angle is between 30 and 90 degrees with respect to the major surface of the welded component.

7. The vehicle of claim 1, wherein the pair of laser welds are positioned symmetrically about a centerline of the continuous intermetallic layer.

8. A welded component comprising:
a first metal layer comprising a first conductivity; and
a second metal layer comprising a second conductivity different than the first conductivity;
wherein the first metal layer and the second metal layer are joined at a faying interface of a resistance spot-weld joint, the resistance spot-weld joint comprising:
a continuous intermetallic layer at the faying interface directly between the first metal layer and the second metal layer; and
a pair of laser welds positioned on opposite sides of the continuous intermetallic layer, the pair of laser welds penetrating through the second metal layer and terminating within the first metal layer, the pair of laser welds extending into the first metal layer beyond a topmost surface of the continuous intermetallic layer.

9. The welded component of claim 8, wherein the welded component further comprises a third metal layer, the third metal layer comprising a third conductivity different than the first conductivity.

10. The welded component of claim 9, wherein the resistance spot-weld joint further comprises a weld nugget between the second metal layer and the third metal layer.

11. The welded component of claim 8, wherein at least one of the laser welds of the pair of laser welds is perpendicular to a major surface of the welded component.

12. The welded component of claim 8, wherein at least one of the laser welds of the pair of laser welds is positioned at an angle towards the continuous intermetallic layer with respect to a major surface of the welded component.

13. The welded component of claim 12, wherein the angle is between 30 and 90 degrees with respect to the major surface of the welded component.

14. The welded component of claim 8, wherein the pair of laser welds are positioned symmetrically about a centerline of the continuous intermetallic layer.

15. A method comprising:
providing a first metal layer comprising a first conductivity;
providing a second metal layer comprising a second conductivity different than the first conductivity;
joining the first metal layer to the second metal layer at a faying interface using resistance spot welding, thereby forming a resistance spot-weld joint, the resistance spot-weld joint comprising a continuous intermetallic layer at the faying interface directly between the first metal layer and the second metal layer; and
forming a pair of laser welds on opposite sides of the continuous intermetallic layer, the pair of laser welds penetrating through the second metal layer and terminating within the first metal layer, the pair of laser welds extending into the first metal layer beyond a topmost surface of the continuous intermetallic layer.

16. The method of claim 15, further comprising providing a third metal layer, the third metal layer comprising a third conductivity different than the first conductivity.

17. The method of claim 16, wherein the resistance spot-weld joint further comprises a weld nugget between the second metal layer and the third metal layer.

18. The method of claim 15, wherein at least one of the laser welds of the pair of laser welds is perpendicular to a major surface of a welded component.

19. The method of claim 15, wherein at least one of the laser welds of the pair of laser welds is positioned at an angle towards the continuous intermetallic layer with respect to a major surface of a welded component.

20. The method of claim 19, wherein the angle is between 30 and 90 degrees with respect to the major surface of the welded component.
